(19) United States
(12) Patent Application Publication
(10) Pub. No.: US 2005/0243687 A1
(43) Pub. Date: Nov. 3, 2005

(54) Mounting structure of total reflection mirror in optical pickup

(75) Inventor: Taiki Mori, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/115,300

(22) Filed: Apr. 27, 2005

(30) Foreign Application Priority Data
Apr. 28, 2004 (JP) P2004-132706

(51) Int. Cl. G11B 7/00

(52) U.S. Cl. 369/112.29

(57) ABSTRACT

A leaf spring is integrally provided on an opto cover for protecting a total reflection mirror, a leaf spring portion being bent downward, a bent end portion of the leaf spring portion being curved inward, such that a curved portion thereof is brought into pressure contact with an end portion 1b on one side of a reverse surface of the total reflection mirror. At an end portion on the other side of the reverse surface of the total reflection mirror, another leaf spring portion corresponding to the end portion is bent upward, an end portion of the bent portion thereof being curved toward the end portion on the other side of the reverse surface of the total reflection mirror, such that a curved portion thereof is brought into pressure contact with the end portion on the other side of the reverse surface.

### BACKGROUND OF THE INVENTION

1. Field of the Invention

The present invention relates to a mounting structure of a total reflection mirror in an optical pickup which is mounted on a slide base supported so as to be capable of being moved close to and away from an optical disk, and which bends an optical axis of laser light emitted from a light source so as to irradiate the optical disk.

2. Description of the Related Art

Conventionally, in the mounting structure of a total reflection mirror in an optical pickup of this type, since the total reflection mirror is fixed to a portion of a main body portion of the optical pickup only by an adhesive, there has been a possibility of this total reflection mirror becoming dislocated due to an environment test.

A first conventional technique is shown in FIGS. 4A and 4B. As shown in FIGS. 4A and 4B, this conventional optical pickup apparatus has a slide base 113 which is supported so as to be capable of being moved close to and away from an optical disk, as well as a prism mirror 116 which is mounted on this slide base 113 and is adapted to bend the optical axis of laser light emitted from a light source and to irradiate the optical disk, so as to effect the recording and/or reproduction of an information signal with respect to the optical disk. The following are formed in the slide base 113: a mirror accommodating hole 122 for accommodating the prism mirror 116; a pair of inclined protrusions 123 provided in the mirror accommodating hole 122 to support a laser light reflecting surface 116a of the prism mirror 116; and a pair of pressing pieces 126 provided in peripheral edge portions of the mirror accommodating hole 122 and each formed by cutting out a thin-walled portion 124 into the mirror accommodating hole 122. The prism mirror 116 is arranged to be fixed by the pressing pieces 126. (Refer to JP-A-2000-57618, for example.)

However, with this apparatus, since the prism mirror 116 is fixed, there has been a problem in that it is impossible to make adjustment of the prism mirror 116.

A second conventional technique is shown in FIGS. 5, 6A, and 6B As shown in FIGS. 5, 6A, and 6B, in this conventional optical pickup apparatus, a half mirror 202 is supported by a pair of mirror holding portions 206. The half mirror 202 is held in close contact with and fixed to a mirror adhesive holding surface 207a of one mirror holding portion 206 by means of an adhesive 209 and to a mirror abutting and holding surface 207b of the other mirror holding portion 206 by means of a spring 208. In this construction, a groove 210 is provided in the mirror adhesive holding surface 207a for fixing the half mirror 202. (Refer to JP-A-8-111027, for example.)

With this conventional technique, however, since the half mirror 202 is fixed by the spring 208, there has been a problem in that the half mirror 202 is unstable.

### SUMMARY OF THE INVENTION

The invention has been devised in view of the above-described conventional problems, and its object is to provide a mounting structure of a total reflection mirror in an optical pickup which makes it possible to mechanically suppress the dislocation of the total reflection mirror due to an environmental test and reduce the amount of dislocation of the total reflection mirror.

The invention has been proposed to overcome the above-described problems, according to a first aspect of the invention, there is provided a mounting structure of a total reflection mirror in an optical pickup which is mounted on a slide base supported so as to be capable of being moved close to and away from an optical disk, and which bends an optical axis of laser light emitted from a light source so as to irradiate the optical disk, characterized in that the total reflection mirror is obliquely supported by a mirror holding portion of a main body portion of the optical pick up, that a leaf spring is integrally provided on an opto cover for protecting the total reflection mirror, a leaf spring portion of the leaf spring being bent downward, an end portion of the leaf spring portion being curved inward, such that a curved portion thereof is brought into pressure contact with an end portion on one side of a reverse surface of the total reflection mirror, and that at an end portion on another side of the reverse surface of the total reflection mirror, another leaf spring portion corresponding to the end portion is bent diagonally upward, an end portion of a bent portion thereof being curved toward the end portion on the other side of the reverse surface of the total reflection mirror, such that a curved portion thereof is brought into pressure contact with the end portion on the other side of the reverse surface of the total reflection mirror, whereby the total reflection mirror is held by the leaf spring.

According to a second aspect of the invention, there is provided a mounting structure of a total reflection mirror in an optical pickup which is mounted on a slide base supported so as to be capable of being moved close to and away from an optical disk, and which bends an optical axis of laser light emitted from a light source so as to irradiate the optical disk, characterized in that the total reflection mirror is obliquely supported by a mirror holding portion of a main body portion of the optical pick up, and that a leaf spring is integrally provided on an opto cover for protecting the total reflection mirror, a leaf spring portion of the leaf spring being bent toward a reverse surface side of the total reflection mirror and is brought into pressure contact with the reverse surface of the total reflection mirror, to thereby hold the total reflection mirror.

According to a third aspect of the invention, the leaf spring portion is provided in a portion of the opto cover located in a vicinity of the reverse surface of the total reflection mirror, a vicinity portion thereof being bent along the reverse surface of the total reflection mirror, such that a substantially entire portion of a bent portion thereof is brought into pressure contact with the reverse surface of the total reflection mirror leading substantially up to the end portion on the one side of the reverse surface. Further, a leaf spring portion corresponding to the end portion on the other side of the reverse surface of the total reflection mirror is bent diagonally upward, and an end portion of a bent portion thereof is curved toward the end portion on the other side of the reverse surface of the total reflection mirror, such that a curved portion thereof is brought into pressure contact with the end portion on the other side of the reverse surface of the total reflection mirror.

According to a fourth aspect of the invention, the leaf spring port-on is provided in a portion of the opto cover located in close proximity to the total reflection mirror, the leaf spring portion being bent diagonally upward, an end portion of a bent portion thereof being brought into pressure contact with a close-proximity portion of the reverse surface of the total reflection mirror.

In accordance with the first aspect of the invention, a curved portion of an end portion of a leaf spring portion provided integrally on the opto cover and bent downward is brought into pressure contact with an end portion on one side of a reverse surface of the total reflection mirror supported by a mirror holding portion of a main body portion of the optical pickup. At the same time, a curved portion of an end portion of a leaf spring portion corresponding to an end portion on the other side of the reverse surface of the total reflection mirror is brought into pressure contact with the end portion on the other side of the reverse surface of the total reflection mirror. Therefore, it is possible to mechanically suppress the dislocation of the total reflection mirror due to an environmental test and reduce the amount of dislocation of the total reflection mirror.

In accordance with the second aspect of the invention, a bent portion of a leaf spring portion provided integrally on the opto cover and bent toward the reverse surface side of the total reflection mirror is brought into pressure contact with the reverse surface of the total reflection mirror supported by a mirror holding portion of a main body portion of the optical pickup. Therefore, it is possible to mechanically suppress the dislocation of the total reflection mirror due to an environmental test and reduce the amount of dislocation of the total reflection mirror.

In accordance with the third aspect of the invention, the leaf spring portion provided in a portion of the opto cover located in a vicinity of the reverse surface of the total reflection mirror is bent and is brought into pressure contact with the reverse surface of the total reflection mirror leading substantially up to the end portion on the one side of the reverse surface. At the same time, a leaf spring portion is curved toward the end portion on the other side of the reverse surface of the total reflection mirror and is brought into pressure contact with the end portion on the other side of the reverse surface of the total reflection mirror. Therefore, it is possible to mechanically suppress further the dislocation of the total reflection mirror due to an environmental test and further reduce the amount of dislocation of the total reflection mirror.

In accordance with the fourth aspect of the invention, the end of the bent portion of the leaf spring portion at the portion of the opto cover located in close proximity to the total reflection mirror is brought into pressure contact with the portion of the total reflection mirror located in close proximity to the reverse surface thereof. Therefore, it is possible to mechanically suppress the dislocation of the total reflection mirror due to an environmental test and reduce the amount of dislocation of the total reflection mirror. In addition, since only one leaf spring portion is provided, it is possible to simplify the structure.

### BRIEF DESCRIPTION OF THE DRAWINGS

These and other objects and advantages of this invention will become more fully apparent from the following detailed description taken with the accompanying drawings in which:

FIGS. 1A and 1B are diagrams illustrating a mounting structure of a total reflection mirror in an optical pickup in accordance with a first embodiment of the invention, in which FIG. 1A is a perspective view thereof and FIG. 1B is a vertical cross-sectional view thereof;

FIG. 2 is a vertical cross-sectional view illustrating the mounting structure of a total reflection mirror in an optical pickup in accordance with a second embodiment;

FIG. 3 is a vertical cross-sectional view illustrating the mounting structure of a total reflection mirror in an optical pickup in accordance with a third embodiment;

FIGS. 4A and 43 are diagrams illustrating a state of mounting a prism mirror in a conventional optical pickup, in which FIG. 4A is a perspective view thereof and FIG. 4B is a vertical cross-sectional view thereof;

FIG. 5 is a schematic diagram illustrating an optical system of a conventional optical pickup apparatus;

FIG. 6A is an enlarged perspective view of a half mirror of the optical pickup apparatus shown in FIG. 5; and

FIG. 6B is an enlarged cross-sectional view of the half mirror shown in FIG. 6A.

### DETAILED DESCRIPTION OF THE PREFERRED EMBODIMENTS

Referring now to the accompanying drawings, a description will be given of an embodiment of the mounting structure of a total reflection mirror in an optical pickup in accordance with the invention.

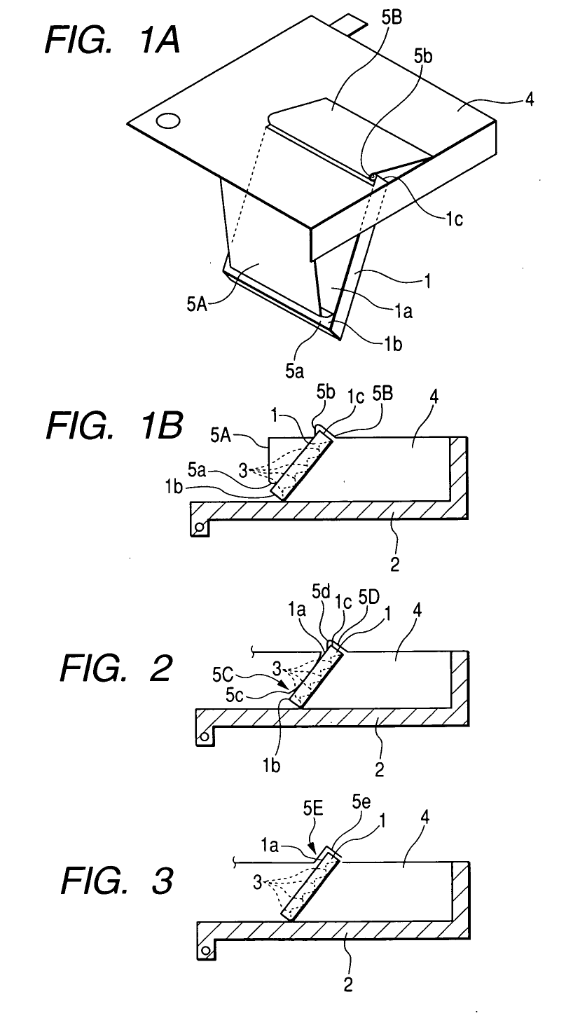

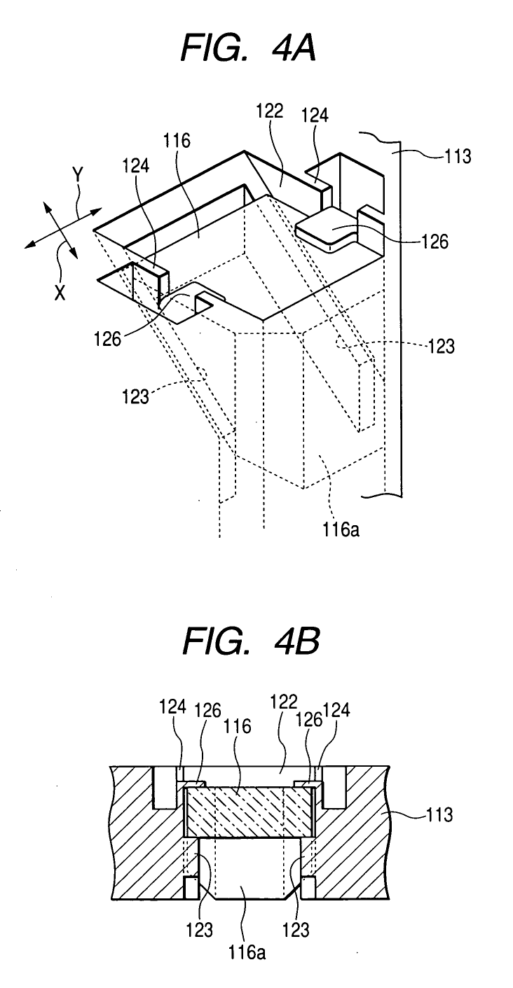

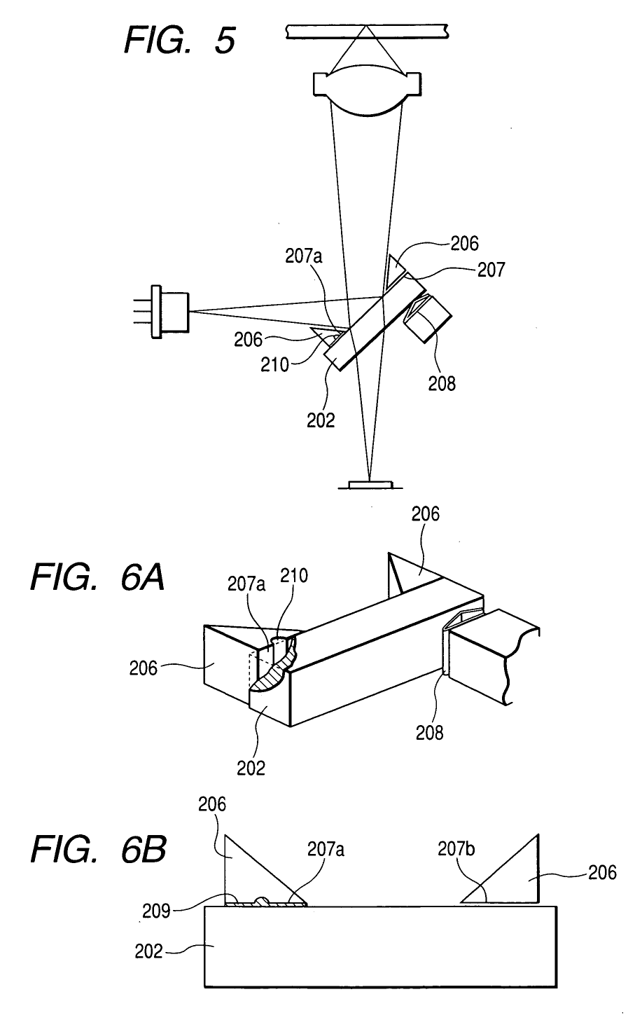

FIGS. 1A and 1B illustrate the mounting structure of a total reflection mirror in an optical pickup in accordance with a first embodiment of the invention in which FIG. 1A is a perspective view thereof and FIG. 1B is a vertical cross-sectional view thereof.

In the mounting structure of a total reflection mirror in an optical pickup in accordance with the first embodiment, as shown in FIGS. 1A and 1B, a total reflection mirror 1 is mounted on a slide base 2 in an in an oblique direction. Both side portions of the total reflection mirror 1 are obliquely supported by a pair of mirror holding portions 3 of a main body portion of the optical pick up. An opto cover 4 for protecting this total reflection mirror 1 is disposed on the upper side of the total reflection mirror. Besides, the opto cover 4 includes an opening on a side of a light source and a side of a optical disk, respectively. Laser light emitted from the light source passes the opening disposed on the side of the light source, and is bent by the total reflection mirror 1, and the bent laser light passes the opening disposed on the side of the optical disk. A leaf spring is integrally provided on this opto cover 4, this leaf spring portion 5A is bent downward, and its end portion is curved inward. An end of this curved portion 5a is brought into pressure contact with an end portion 1b on one side of a reverse surface 1a of the total reflection mirror 1. In addition, at an end portion 1c on the other side of the reverse surface 1a of the total reflection mirror 1, a leaf spring portion 5B corresponding to this end portion 1c is bent diagonally upward. An end portion of this bent portion is curved toward the end portion 1c on the other side of the reverse surface 1a of the total reflection mirror 1, and this curved portion 5b is brought into pressure contact with the end portion 1c on the other side of the reverse surface 1a of the total reflection mirror 1. By virtue of this structure, the total reflection mirror 1 is held by the two leaf spring portions 5A and 5B, The two leaf spring portions 5A and 55 provided integrally on the opto cover 4 are brought into pressure contact.

According to this first embodiment, the curved portions 5a and 5b of the respective end portions of the two leaf spring portions 5A and 5B provided integrally on the opto cover 4 are respectively brought into pressure contact with the end portion 1b on the one side and the end portion 1c on the other side of the reverse surface 1a of the total reflection mirror 1. Therefore, it is possible to mechanically suppress the dislocation of the total reflection mirror 1 due to an environmental test and reduce the amount of dislocation of the total reflection mirror 1.

FIG. 2 is a vertical cross-sectional view illustrating the mounting structure of a total reflection mirror in an optical pickup in accordance with a second embodiment.

In the mounting structure of a total reflection mirror in an optical pickup in accordance with the second embodiment, as shown in FIG. 2, a leaf spring portion 5C on the one side is provided in a portion of the opto cover 4 located in the vicinity of the reverse surface 1a of the total reflection mirror 1. This vicinity portion is bent along the reverse surface la of the total reflection mirror 1, such that a substantially entire portion of this bent portion 5c is brought into pressure contact with the reverse surface 1a of the total reflection mirror 1 leading substantially up to the end portion 1b on the one side of the reverse surface 1a. A leaf spring portion 5D on the other side is provided at a portion corresponding to the end portion 1c on the other side of the total reflection mirror 1. This leaf spring portion 5D is bent diagonally upward, an end portion of this bent portion 5d is curved toward the end portion 1c on the other side of the reverse surface 1a of the total reflection mirror 1, and this curved portion 5d is brought into pressure contact with the end portion 1c on the other side of the reverse surface 1a of the total reflection mirror 1.

According to this second embodiment, a substantially entire portion of the bent portion 5c of the leaf spring portion 5C on the one side is brought into pressure contact with the reverse surface 1a of the total reflection mirror 1 leading substantially up to the end portion 1b on the one side of the total reflection mirror 1. Therefore, it is possible to mechanically suppress further the dislocation of the total reflection mirror 1 due to an environmental test and further reduce the amount of dislocation of the total reflection mirror 1. Furthermore, since the curved portion 5d at the end of the bent portion of the leaf spring portion 5D on the other side is brought into pressure contact with the end portion 1c on the other side of the reverse surface 1a of the total reflection mirror 1, this also makes it possible to suppress the dislocation of the total reflection mirror 1 and reduce the amount of dislocation of the total reflection mirror 1.

FIG. 3 is a vertical cross-sectional view illustrating the mounting structure of a total reflection mirror in an optical pickup in accordance with a third embodiment.

In the mounting structure of a total reflection mirror in an optical pickup in accordance with the third embodiment, as shown in FIG. 3, a leaf spring portion 5E is provided at a portion of the opto cover 4 located in close proximity to the total reflection mirror 1. This leaf spring portion 5E is bent diagonally upward, and an end portion of this bent portion 5e is further bent diagonally downward and is brought into pressure contact with a portion of the total reflection mirror 1 located in close proximity to the reverse surface 1a thereof.

According to this third embodiment, the end of the bent portion 5e of the leaf spring portion 5E at the portion of the opto cover 4 located in close proximity to the total reflection mirror 1 is brought into pressure contact with the portion of the total reflection mirror 1 located in close proximity to the reverse surface 1a thereof. Therefore, it is possible to mechanically suppress the dislocation of the total reflection mirror 1 due to an environmental test and reduce the amount of dislocation of the total reflection mirror 1. In addition, since only one leaf spring portion 5E is provided, it is possible to simplify the structure.

It should be noted that the leaf spring portions are not limited to those shown in the respective embodiments, and it goes without saying that the leaf spring portions maybe provided at other portions of the opto cover 4 and may be brought into pressure contact with the reverse surface 1a of the total reflection mirror 1.

1. Amounting structure of a total reflection mirror in an optical pickup which is mounted on a slide base supported so as to be capable of being moved close to and away from an optical disk, and which bends an optical axis of laser light emitted from a light source so as to irradiate the optical disk, the mounting structure comprising:
a mirror holding portion of a main body portion of the optical pick up, for obliquely supporting the total reflection mirror; and
leaf spring portions that are integrally provided on an opto cover for protecting the total reflection mirrors wherein:
one of the leaf spring portions is bent downward:
an end portion of the one of the leaf spring portion which is bent is curved inward;
the end portion of the one of the leaf spring portion which is curved is brought into pressure contact with an end portion on one side of a reverse surface of the total reflection mirror;
another leaf spring portion corresponding to an end portion on another side of the reverse surface of the total reflection mirror is bent diagonally upward;
an end portion of a bent portion of the another leaf spring portion is curved toward the end portion on the other side of the reverse surface of the total reflection mirror;
a curved portion of the another leaf spring portion is brought into pressure contact with the end portion on the other side of the reverse surface of the total reflection mirror; and
the total reflection mirror is held by the leaf spring portions.

2. A mounting structure of a total reflection mirror in an optical pickup which is mounted on a slide base supported so as to be capable of being moved close to and away from an optical disk, and which bends an optical axis of laser light emitted from a light source so as to irradiate the optical disk, the mounting structure comprising:
a mirror holding portion of a main body portion of the optical pick up, for obliquely supporting the total reflection mirror;
a leaf spring portions that is integrally provided on an opto cover for protecting the total reflection mirror, wherein;
the leaf spring portion is bent toward a reverse surface side of the total reflection mirror and is brought into pressure contact with the reverse surface of the total reflection mirror, in order to hold the total reflection mirror.

3. A mounting structure of a total reflection mirror in an optical pickup which is mounted on a slide base supported so as to be capable of being moved close to and away from an optical disk, and which bends an optical axis of laser light emitted from a light source so as to irradiate the optical disk, the mounting structure comprising:
a mirror holding portion of a main body portion of the optical pick up, for obliquely supporting the total reflection mirror;
leaf spring portions that are integrally provided on an opto cover for protecting the total reflection mirror, wherein:
one of the leaf spring portion is provided in a portion of the opto cover located in a vicinity of the reverse surface of the total reflection mirror;
the one of the leaf spring portion is bent along the reverse surface of the total reflection mirror;
a substantially entire portion of the one of the leaf spring portion which is bent is brought into pressure contact with the reverse surface of the total reflection mirror leading substantially up to the end portion on the one side of the reverse surface;
another leaf spring portion corresponding to the end portion on the other side of the reverse surface of the total reflection mirror is bent diagonally upward;
an end portion of a bent portion of the another leaf spring portion is curved toward the end portion on the other side of the reverse surface of the total reflection mirror;
a curved portion of the another leaf spring portion is brought into pressure contact with the end portion on the other side of the reverse surface of the total reflection mirror; and
the total reflection mirror is held by the leaf spring portions.

4. The mounting structure according to claim 2, wherein:
the leaf spring portion is provided in a portion of the opto cover located in close proximity to the total reflection mirror;
the leaf spring portion is bent diagonally upward; and
an end portion of a bent portion of the leaf spring portion is brought into pressure contact with a close-proximity portion of the reverse surface of the total reflection mirror.
